(19) United States
(12) Patent Application Publication
(10) Pub. No.: US 2012/0328977 A1
(43) Pub. Date: Dec. 27, 2012

(54) TONER AND PROCESS FOR PRODUCTION THEREOF

(75) Inventors: Masahiro Ikuta, Shizuoka-ken (JP); Takayasu Aoki, Shizuoka-ken (JP); Tsuyoshi Itou, Shizuoka-ken (JP); Motonari Udo, Shizuoka-ken (JP); Takafumi Hara, Shizuoka-ken (JP); Kazuhisa Takeda, Shizuoka-ken (JP)

(73) Assignee: TOSHIBA TEC KABUSHIKI KAISHA, Tokyo (JP)

(21) Appl. No.: 13/525,627

(22) Filed: Jun. 18, 2012

Related U.S. Application Data
(60) Provisional application No. 61/500,354, filed on Jun. 23, 2011.

(51) Int. Cl. G03G 9/093

(52) U.S. Cl. 430/109.1; 430/137.11

(57) ABSTRACT

Encapsulated toner particles are formed by: aggregating core material particles containing at least a colorant and a core material resin in an aqueous dispersion medium to form core particles; adding coating resin particles into the aqueous dispersion medium during progress of the formation of the core material at a point of time when the volume-based median particle diameter of the core particles formed by the aggregation reaches 30 to 83% of that of desired toner particles; and continuing the aggregation to form a coating layer composed of a composite aggregate of the core material particles and the coating resin particles on the core material. In the thus-obtained toner, the colorant is uniformly and well incorporated in the toner particles, and therefore, the coloring ability is improved without causing a problem of release of fine powder.

### CROSS-REFERENCE TO RELATED APPLICATIONS

This application is based upon and claims the benefit of priority from U.S. provisional application 61/500,354, filed on Jun. 23, 2011; the entire contents of which are incorporated herein by reference.

### FIELD

Embodiments described herein relate generally to an electrophotographic toner and a process for production thereof.

### BACKGROUND

Conventionally, in an electrophotographic process, an electric latent image is formed on an image carrying member, the latent image is developed with a toner, a toner image is transferred onto a transfer material such as paper and then fixed thereto by means of heating, pressing, etc. As for a toner to be used, in order to form a full color image, not only a conventional toner of a single color of black, but also toners of a plurality of colors are used to form such an image.

As the toner, a two-component developer to be used by mixing with carrier particles and a one-component developer to be used as a magnetic toner or a non-magnetic toner are known. These toners are produced by a dry process or a wet process. A kneading and pulverization method, which is the dry process, is a method for producing desired toner particles by melt-kneading a binder resin, a pigment, a release agent such as a wax, a charge control agent, etc., cooling the resulting mixture, followed by finely pulverizing the cooled mixture, and then classifying the finely pulverized mixture. Inorganic and/or organic fine particles are added for attaching to surfaces of toner particles produced by the kneading and pulverization method in accordance with the intended use, and thus, the toner is obtained.

When toner particles are produced by the kneading and pulverization method, their shapes are indefinite and their surface compositions are not uniform in general. Although the shapes and the surface compositions of the toner particles are subtly changed depending on the pulverizability of the material to be used and conditions for the pulverization step, it is difficult to intentionally control the shapes and the surface compositions.

As the wet process, there is employed a method for obtaining toner particles by preparing a resin dispersion liquid through emulsion polymerization, and also separately preparing a colorant dispersion liquid in which a colorant is dispersed in a solvent, mixing these dispersion liquids to form aggregated particles with a size corresponding to a toner particle diameter, and fusing the aggregated particles by heating. According to this emulsion polymerization-aggregation method, by selecting a heating temperature condition, the toner shapes can be arbitrarily controlled from an indefinite to a spherical shape. Examples of the wet process other than the emulsion polymerization-aggregation method include a phase-inversion emulsification method in which a pigment dispersion liquid or the like is added to a solution obtained by dissolution in an organic solvent, and water is added thereto, and a mechanical shearing and aggregation method in which fine particles are prepared by mechanical shearing in an aqueous medium without using an organic solvent, followed by aggregation and fusion. Further, there is employed a method for producing an encapsulated toner having a core-shell structure by forming aggregated particles (core particles) and thereafter adding fine particles (shell particles). However, this method has disadvantages (problems) that it is difficult to control the particle diameter, and therefore, a variation thereof in toner production is liable to occur, and that the colorant is unevenly dispersed, and the coloring ability is insufficient.

### DETAILED DESCRIPTION

Embodiments described herein include the following:

a toner, including: encapsulated toner particles each having a core particle composed of an aggregate of core material particles containing at least a colorant and a core material resin and having a coating layer for coating the core particle, which coating layer is composed of a composite aggregate of the core material particles and coating resin particles, wherein the volume-based median particle diameter of the core material is from 30 to 80% of that of the toner particles; and

a process for producing a toner, including: aggregating core material particles containing at least a colorant and a core material resin in an aqueous dispersion medium to form core particles; additionally charging coating resin particles into the aqueous dispersion medium during progress of the formation of the core material at a point of time when the volume-based median particle diameter of the core particles formed by the aggregation has reached 30 to 83% of that of desired toner particles; and continuing the aggregation to form a coating layer composed of a composite aggregate of the core material particles and the coating resin particles on the core material, thereby forming encapsulated toner particles. Herein, the core material particles may comprise either one type of particles including both the resin and the colorant, or a mixture of colorant particles and core material resin particles.

These embodiments provide the following effects.

By allowing aggregation to proceed while adding coating resin particles so as to control the particle diameter of the aggregated particles, the color material is allowed to exist more uniformly in the toner, and therefore, the coloring ability is improved, and also the incorporation of the colorant is improved.

Even in case where a release agent is used, by improving the incorporation of the release agent and allowing the same to exist in the vicinity of surfaces of the particles, the anti-offset property is improved and the occurrence of filming is suppressed.

Further, it becomes easy to control the particle diameter, and a variation thereof in the production process can be suppressed.

More specifically, in case where aggregation of core material fine particles comprising colorant particles, resin fine particles and preferably also a release agent, is proceeded up to a proximity of the desired final particle size of the objective toner, followed by quick addition and attachment of coating resin fine particles and fusion thereof for encapsulation, the colorant, especially an encapsulated colorant, and the release agent having poor mutual solubility with the core material resin, can only attach to the vicinity of the aggregated core particles in a readily releasable state. Accordingly, if the coating resin fine particles are subsequently quickly added to be attached thereto, the colorant and the release agent cannot be effectively covered with the coating resin layer but are liable to be incorporated in the toner in such a state that they are readily released from the final toner particles, thus causing occurrence of fine powder and a broad particle size distribution. In other words, in the process of aggregating particles, the aggregated particles are formed in a coarse or somewhat loose state retaining many gaps between the particles. When these loosely aggregated particles are subjected to fusion accompanied with melting of the resin, the colorant particles and the release agent having poor mutual solubility (or compatibility) with the resin are liable to be exposed to or liberated from the surfaces of the aggregated toner particles.

In contrast thereto, if the initial aggregation of core material fine particles is not completed by themselves but is moderately completed in the co-presence of additionally charged coating resin fine particles, also the colorant fine particles, etc., having poor mutual solubility with the core material resin can be well taken into a composite aggregate coating layer together with the coating resin fine particles, thus being uniformly incorporated in the encapsulated toner particles. More specifically, after the subsequent addition of the coating resin fine particles, the aggregation is assumed to proceed in the following manner. Thus, the subsequently added coating resin fine particles are caused to fill the gaps between the aggregated particles to proceed with the aggregation of the particles. The subsequent addition of the coating resin fine particles results in a dispersion liquid for production of toner particles wherein the core material fine particles, aggregates of the core material fine particles and the coating resin fine particles are co-present. By adding the coating resin fine particles in an intermediate stage of the aggregation, the coating resin fine particles intrude into and fill in the gaps between the aggregated particles and thereafter promote the aggregation, as if it is a primer, so as to take in not only the coating resin fine particles but also core material resin particles (particularly core material resin fine particles) or the aggregates of core material resin particles (particularly aggregates of core material resin fine particles).

Hereinafter, embodiments will be described more specifically. In the following description, “part(s)” and “%” representing a composition are expressed by weight unless otherwise specified.

The step of aggregation of only the core material particles (fine or source particles to be aggregated) is terminated when the volume-based median particle diameter (which refers to a median diameter at which a cumulative volume percent counted either from the smaller particle diameter side or the larger particle diameter side in a measured particle size distribution amounts to 50% by volume, hereinafter sometimes referred to as “D50”) of the core particles to be formed has reached 30 to 83%, preferably 35 to 83%, more preferably 40 to 75%, of that of the desired toner particles. Then, the addition of the coating resin particles (fine or source particles to be aggregated) is started to continue the aggregation until the aggregation is completed. Thereafter, the aggregates are heated and fused, whereby encapsulated toner particles are formed. If the volume-based median particle diameter of the core particles at the time of finishing the step of aggregation of only the core material particles is less than 30% of that of the desired toner particles, the resultant core particles become too small, thus being liable to leave un-aggregated colorant particles which cannot be incorporated in the toner particles even after the addition of the coating resin particles (see Comparative Example 1 described later). On the other hand, if the volume-based median particle diameter thereof at that time exceeds 83% of that of the desired toner particles, it is difficult to attain the above-described effects in the formation of the encapsulated toner particles (see Comparative Example 1 described later). The coating resin particles can also be added in two or more portions.

### [Used Materials]

In this embodiment, any known materials can be used for a resin, a colorant, a color-forming compound, a color-developing agent, a release agent, a charge control agent, an aggregating agent and a neutralizing agent.

### [Resin]

Examples of a binder resin to be used as the core material resin or the coating resin in this embodiment include: styrene-based resins, such as polystyrene, styrene/butadiene copolymers and styrene/acrylic copolymers; ethylene-based resins, such as polyethylene, polyethylene/vinyl acetate copolymers, polyethylene/norbornene copolymers and polyethylene/vinyl alcohol copolymers; polyester resins, acrylic resins, phenolic resins, epoxy-based resins, allyl phthalate-based resins, polyamide-based resins and maleic acid-based resins. These resins can be used alone or in combination of two or more species thereof. These resins may be used in combination in either of the core material resin and the coating resin. The coating resin is preferably contained within a range of from 5 to 60%, particularly 10 to 50% of the total amount of the resin constituting the toner.

As the binder resin, particularly, a polyester resin or a styrene/acrylic copolymer having an acid value of preferably 1 or more (mg-KOH/g) is preferably used.

### [Colorant]

Examples of the colorant to be used in this embodiment include: carbon blacks, and organic or inorganic pigments or dyes. Examples of the carbon blacks include acetylene black, furnace black, thermal black, channel black and Ketjen black. Further, examples of yellow pigments include C.I. Pigment Yellow 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183 and 185; and C.I. Vat Yellow 1, 3 and 20. These can be used alone or in admixture. Examples of magenta pigments include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209 and 238; C.I. Pigment Violet 19; and C.I. Vat Red 1, 2, 10, 13, 15, 23, 29 and 35. These can be used alone or in admixture. Examples of cyan pigments include C.I. Pigment Blue 2, 3, 15, 16 and 17; C.I. Vat Blue 6 and C.I. Acid Blue 45. These can be used alone or in admixture.

### [Color-Forming Compound]

The colorant can also be a decolorable color material containing the color-forming compound and the color-developing agent in combination. The color-forming compound is represented by a leuco dye and is an electron-donating compound capable of forming a color by the action of the color-developing agent. Examples thereof include diphenylmethane phthalides, phenylindolyl phthalides, indolyl phthalides, diphenylmethane azaphthalides, phenylindolyl azaphthalides, fluorans, styrynoquinolines and diaza-rhodamine lactones.

Specific examples thereof include 3,3-bis(p-dimethylaminophenyl)-6-dimethylaminophthalide, 3-(4-diethylaminophenyl)-3-(1-ethyl-2-methylindol-3-yl)phthalide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylindol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrano(2,3-d)pyrimidine-5,1′(3′H)isobenzofuran]-3′-one, 2-(diethylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-methyl-, spiro[5H-(1)benzopyrano(2,3-d)pyrimidine-5,1′(3′H)isobenzofuran]-3′-one, 2-(di-n-butylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(N-ethyl-N-i-amylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide and 3-(2-ethoxy-4-diethylaminophenyl)-3-(1-pentyl-2-methylindol-3-yl)-4,5,6,7-tetrachlorophthalide. Additional examples thereof include pyridine compounds, quinazoline compounds and bisquinazoline compounds. These compounds can also be used by mixing two or more species thereof.

### [Color-Developing Agent]

As the color-developing agent which causes the color-forming compound to form a color, an electron-accepting compound which donates a proton to the leuco dye may be used. Examples thereof include: phenols, metal salts of phenols, metal salts of carboxylic acids, aromatic carboxylic acids, aliphatic carboxylic acids having 2 to 5 carbon atoms, sulfonic acids, sulfonates, phosphoric acids, metal salts of phosphoric acids, acidic phosphoric acid esters, metal salts of acidic phosphoric acid esters, phosphorous acids, metal salts of phosphorous acids, monophenols, polyphenols, 1,2,3-triazole and derivatives thereof. Additional examples thereof include those having, as a substituent, an alkyl group, an aryl group, an acyl group, an alkoxycarbonyl group, a carboxy group or an ester thereof, an amide group, a halogen group, etc., and bisphenols, trisphenols, phenolaldehyde condensed resins and metal salts thereof. These compounds may be used alone or by mixing two or more species thereof.

Specific examples thereof include: phenol, o-cresol, tertiary butyl catechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate, dihydroxybenzoic acid or esters thereof (such as 2,3-dihydroxybenzoic acid and methyl 3,5-dihydroxybenzoate), resorcin, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyl)ethane, 1,1-bis(4-hydroxyphenyl)-3-methylbutane, 1,1-bis(4-hydroxyphenyl)-2-methylpropane, 1,1-bis(4-hydroxyphenyl)-n-hexane, 1,1-bis(4-hydroxyphenyl)-n-heptane, 1,1-bis(4-hydroxyphenyl)-n-octane, 1,1-bis(4-hydroxyphenyl)-n-nonane, 1,1-bis(4-hydroxyphenyl)-n-decane, 1,1-bis(4-hydroxyphenyl)-n-dodecane, 2,2-bis(4-hydroxyphenyl)butane, 2,2-bis(4-hydroxyphenyl)ethyl propionate, 2,2-bis(4-hydroxyphenyl)-4-methylpentane, 2,2-bis(4-hydroxyphenyl)hexafluoropropane, 2,2-bis(4-hydroxyphenyl)-n-heptane 2,2-bis(4-hydroxyphenyl)-n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol and methylenetris-p-cresol.

It is preferred to use the color-developing agent in an amount of from 0.5 to 10 parts, particularly from 1 to 5 parts, per part of the leuco dye. If the amount thereof is less than 0.5 part, the density of the formed color is decreased, and if the amount thereof exceeds 10 parts, it becomes difficult to completely erase the color.

### [Decoloring Agent]

In the decolorable colorant system used in this embodiment, a decoloring agent may be further contained as needed. As the decoloring agent, in a three-component system including the color-forming compound, the color-developing agent and the decoloring agent, a known compound can be used as long as the compound inhibits the coloring reaction between the leuco dye and the color-developing agent through heating, thereby making the system colorless.

As the decoloring agent, particularly, a decoloring agent, which can form a coloring and decoloring system utilizing the temperature hysteresis of a known decoloring agents disclosed in JP-A-60-264285, JP-A-2005-1369, JP-A-2008-280523, etc., has an excellent instantaneous erasing property. When a mixture of such a three-component system in a colored state is heated to a specific decoloring temperature Th or higher, the mixture can be decolored. Further, even if the decolored mixture is cooled to a temperature below Th, the decolored state is maintained. When the temperature of the mixture is further lowered, a coloring reaction between the leuco dye and the color-developing agent is caused again at a specific color restoring temperature Tc or below, and the mixture restores a colored state. In this manner, it is possible to cause a reversible coloring-decoloring reaction. In particular, it is preferred that the decoloring agent to be used in this embodiment satisfies the following relation: Th>Tr>Tc, wherein Tr represents room temperature.

Examples of the decoloring agent capable of causing this temperature hysteresis include alcohols, esters, ketones, ethers and acid amides.

Particularly preferred are esters. Specific examples thereof include esters of carboxylic acids containing a substituted aromatic ring, esters of carboxylic acids containing an unsubstituted aromatic ring with aliphatic alcohols, esters of carboxylic acids containing a cyclohexyl group in each molecule, esters of fatty acids with unsubstituted aromatic alcohols or phenols, esters of fatty acids with branched aliphatic alcohols, esters of dicarboxylic acids with aromatic alcohols or branched aliphatic alcohols, dibenzyl cinnamate, heptyl stearate, didecyl adipate, dilauryl adipate, dimyristyl adipate, dicetyl adipate, distearyl adipate, trilaurin, trimyristin, tristearin, dimyristin and distearin. These compounds may be used alone or by mixing two or more species thereof.

It is preferred to use the decoloring agent in an amount of from 1 to 500 parts, particularly from 4 to 99 parts, per part of the color-forming compound. If the amount thereof is less than 1 part, it becomes difficult to achieve a completely decolored state, and if the amount thereof exceeds 500 parts, the density of the formed color can be decreased.

### [Encapsulation of Colorant]

It is also preferred to supply the colorant as encapsulated fine particles. In particular, in such an encapsulated state, the components forming the above-described decoloring system, i.e., the color-forming compound, the color-developing agent and preferably further the decoloring agent are caused to be present in close contact with each other without interposing other components such as a resin therebetween, a favbrable coloring and decoloring system can be formed. There is a tendency that the compatibility of such encapsulated colorant particles with other toner components such as a resin is reduced, and therefore, the effect of this embodiment can be further exhibited in the case of such encapsulated colorant particles.

An encapsulating agent (shell material) for forming an outer shell of the colorant is not particularly limited and can be appropriately determined by those skilled in the art.

Examples of methods for forming an encapsulated colorant include an interfacial polymerization method, a coacervation method, an in-situ polymerization method, a drying-in-liquid method and a curing-and-coating-in-liquid method.

In particular, an in-situ polymerization method in which a melamine resin is used as a shell component, an interfacial polymerization method in which a urethane resin is used as a shell component, etc., are preferably used.

In the case of the in-situ polymerization method, the above-mentioned three components (the color-forming compound, the color-developing agent, and the decoloring agent which is added if needed) are first dissolved and mixed, and then, the resulting mixture is emulsified in an aqueous solution of a water-soluble polymer or a surfactant. Thereafter, an aqueous solution of a melamine formalin prepolymer is added thereto, followed by heating to effect polymerization, whereby encapsulation can be achieved.

In the case of the interfacial polymerization method, the above-mentioned three components and a polyvalent isocyanate prepolymer are dissolved and mixed, and then, the resulting mixture is emulsified in an aqueous solution of a water-soluble polymer or a surfactant. Thereafter, a polyvalent base, such as a diamine or a diol, is added thereto, followed by heating to effect polymerization, whereby encapsulation can be achieved.

The volume-based median particle diameter (D50) (based on a particle size distribution as measured by a laser method) of the encapsulated colorant is preferably from 0.5 to 3.5 μm. It was experimentally confirmed that when the volume-based median particle diameter (D50) thereof is outside the range of from 0.5 to 3.5 μm, the incorporation of the colorant into the toner particles is reduced. The mechanism of the reduction of the incorporation of the colorant having a small diameter is not exactly known, but, in the case of using the encapsulated colorant, when the particle diameter thereof is less than a given value, the incorporation of the colorant into the binder resin is reduced so that the amount of released fine powder is increased.

Further, although depending on the specific species of the color-forming compound and the color-developing agent, for example, by placing the encapsulated colorant at a temperature, for example, between −20° C. and −30° C., the color-forming compound and the color-developing agent are coupled to each other to form a color.

### [Release Agent]

Examples of the release agent to be used in this embodiment include aliphatic hydrocarbon-based waxes, such as low-molecular weight polyethylenes, low-molecular weight polypropylenes, polyolefin copolymers, polyolefin waxes, microcrystalline waxes, paraffin waxes and Fischer-Tropsch waxes; oxides of an aliphatic hydrocarbon-based wax, such as polyethylene oxide waxes or block copolymers thereof; vegetable waxes, such as candelilla wax, carnauba wax, Japan wax, jojoba wax and rice wax; animal waxes, such as beeswax, lanolin and spermaceti wax; mineral waxes, such as ozokerite, ceresin and petrolactum; waxes containing, as a main component, a fatty acid ester, such as montanic acid ester wax and castor wax; and deoxidation products resulting from deoxidation of a part or the whole of a fatty acid ester, such as deoxidized carnauba wax. Further, saturated linear fatty acids, such as palmitic acid, stearic acid, montanic acid and long-chain alkyl carboxylic acids having a long-chain alkyl group; unsaturated fatty acids, such as brassidic acid, eleostearic acid and parinaric acid; saturated alcohols, such as stearyl alcohol, eicosyl alcohol, behenyl alcohol, carnaubyl alcohol, ceryl alcohol, melissyl alcohol and long-chain alkyl alcohols having a long-chain alkyl group; polyhydric alcohols, such as sorbitol; fatty acid amides, such as linoleic acid amide, oleic acid amide and lauric acid amide; saturated fatty acid bisamides, such as methylenebis stearic acid amide, ethylenebis caprylic acid amide, ethylenebis lauric acid amide and hexamethylenebis stearic acid amide; unsaturated fatty acid amides, such as ethylenebis oleic acid amide, hexamethylenebis oleic acid amide, N,N′-dioleyl adipic acid amide and N,N′-dioleyl sebacic acid amide; aromatic bisamides, such as m-xylenebis stearic acid amide and N,N′-distearyl isophthalic acid amide; fatty acid metal salts (generally called metallic soaps), such as calcium stearate, calcium laurate, zinc stearate and magnesium stearate; waxes obtained by grafting a vinyl-based monomer, such as styrene or acrylic acid onto an aliphatic hydrocarbon-based wax; partially esterified products of a fatty acid and a polyhydric alcohol, such as behenic acid monoglyceride; and methyl ester compounds having a hydroxyl group obtained by hydrogenation of a vegetable fat or oil can be exemplified.

The release agent can be contained in either of the core material particles and the coating layer, but may preferably be contained in the core material so as to prevent the release thereof out of the toner particles and improve the incorporation thereof in the toner particles, while allowing the exudation to the vicinity of the toner particle surfaces according to heating during or after the aggregation and fusion of the particles.

It is preferred to use the release agent such that the total amount of the core material resin and the coating resin may be from 1 to 99 parts, particularly from 2 to 19 parts, per part of the colorant particles (including the amount of an encapsulating agent when used for encapsulating the colorant particles are encapsulated) so as to provide a toner having a softening point of from 60 to 140° C.

### [Charge Control Agent (CCA)]

Examples of the charge control agent for controlling a triboelectric chargeability, which can be used in this embodiment, include positively-chargeable charge control agents, such as nigrosine-based dyes, quaternary ammonium-based compounds and polyamine-based resins; and negatively-chargeable charge control agents, such as metal-containing azo compounds in which a metal element is a complex or a complex salt containing iron, cobalt or chromium, or a mixture thereof and metal-containing salicylic acid derivative compounds in which the metal element is a complex or a complex salt containing zirconium, zinc, chromium or boron, or a mixture thereof. Such a charge control agent may generally be mixed in the core material resin or the coating resin.

### [Mechanical Shearing Device]

In order to pulverize the above-described core material resin, the coating resin, the colorant, etc. to be used in this embodiment, a mechanical shearing device is used as needed. Examples of the mechanical shearing device include media-free stirrers, such as ULTRA TURRAX (made by IKA Japan K.K.), T.K. AUTO HOMO MIXER (made by PRIMIX Corporation), T.K. PIPELINE HOMO MIXER (made by PRIMIX Corporation), T.K. FILMICS (made by PRIMIX Corporation), CLEAR MIX (made by M Technique Co., Ltd.), CLEAR SS5 (made by M Technique Co., Ltd.), CAVITRON (made by EUROTEC, Co., Ltd.) and FINE FLOW MILL (made by Pacific Machinery & Engineering Co., Ltd.); media-type stirrers, such as VISCO MILL (made by Aimex Co., Ltd.), APEX MILL (made by Kotobuki Industries Co., Ltd.), STAR MILL (made by Ashizawa Finetech Co., Ltd.), DCP SUPER FLOW (made by Nippon Eirich Co., Ltd.), MP MILL (made by Inoue Manufacturing Co., Ltd.), SPIKE MILL (made by Inoue Manufacturing Co., Ltd.), MIGHTY MILL (made by Inoue Manufacturing Co., Ltd.) and SC MILL (made by Mitsui Mining Co., Ltd.); and high-pressure impact-type dispersing devices, such as ULTIMIZER (made by Sugino Machine Limited), NANOMIZER (made by Yoshida Kikai Co. Ltd.) and NANO 3000 (made by Beryu Co., Ltd.).

### [Surfactant]

The core material resin, the colorant fine particles, and the particles (fine or source particles to be aggregated) of the coating resin, etc., which can be used in this embodiment, are subjected to the aggregation step as a dispersion liquid in which the particles are dispersed in an aqueous medium containing a surfactant added as needed. Examples of the surfactant include: anionic surfactants, such as sulfate ester salt-based, sulfonate-based, phosphate ester-based and soap-based anionic surfactants; cationic surfactants, such as amine salt-based and quaternary ammonium salt-based cationic surfactants; and nonionic surfactants, such as polyethylene glycol-based, alkyl phenol ethylene oxide adduct-based and polyhydric alcohol-based nonionic surfactants.

### [Aggregating Agent]

In the aggregation step of this embodiment, by adding an aggregating agent to an aqueous dispersion medium containing the colorant particles and the particles of the core material resin (including the release agent as needed), or core material fine particles including both the colorant and the core material resin, preferably at a temperature of from about 20 to 50° C. under an appropriate degree of stirring, the aggregation is started. Examples of the aggregating agent which can be used include: metal salts, such as sodium chloride, calcium chloride, calcium nitrate, barium chloride, magnesium chloride, zinc chloride, magnesium sulfate, aluminum chloride, aluminum sulfate and potassium aluminum sulfate; inorganic metal salt polymers, such as polyaluminum chloride, polyaluminum hydroxide and calcium polysulfide; polymeric aggregating agents, such as polymethacrylic esters, polyacrylic esters, polyacrylamides and acrylamide-sodium acrylate copolymers; coagulating agents, such as polyamines, polydiallyl ammonium halides, melanin formaldehyde condensates and dicyandiamide; alcohols, such as methanol, ethanol, 1-propanol, 2-propanol, 2-methyl-2-propanol, 2-methoxyethanol, 2-ethoxyethanol and 2-butoxyethanol; organic solvents, such as acetonitrile and 1,4-dioxane; inorganic acids, such as hydrochloric acid and nitric acid; and organic acids such as formic acid and acetic acid.

Incidentally, in the state before the aggregation, the core material resin fine particles and the coating resin fine particles each have a volume-based median particle diameter (D50) (based on a particle size distribution as measured by a laser method) of generally 50 nm to 1μm, preferably 50 nm to 500 nm.

### [Neutralizing Agent]

As the neutralizing agent which can be used s needed in this embodiment for stabilizing the dispersion to allow the aggregation to proceed smoothly, an inorganic base or an amine compound can be used. Examples of the inorganic base include sodium hydroxide and potassium hydroxide. Examples of the amine compound include dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane and N,N-diethyl-1,3-diaminopropane.

### [Addition of Coating Resin Particles]

As described above, the coating resin particles (preferably as an aqueous dispersion liquid) are additionally charged when the volume-based median particle diameter of the core material particles formed by the aggregation of the core material particles increased to 30 to 83% of that of the desired toner particles, and the aggregation is continued until the aggregates grow to the particle diameter substantially equal to that of final toner particles. At this time, an appropriate aggregation time of 1 to 12 hours may preferably be taken after the addition of the coating resin particles. Depending on the progress of the aggregation, furthr addition and/or temperature adjustment can be performed as needed. As mentioned above, the coating resin particles may be additionally added in two or more portions.

### [Fusion]

Subsequently to the above-described (at least) two-stage aggregation step, a fusion-stabilizing agent, such as an aqueous solution of sodium polycarboxylate, is added as needed, and then the temperature is gradually raised to a temperature between the glass transition temperature of the resin and about 90° C., preferably under stirring, whereby fusion of the aggregated particles is accelerated. For achieving the fusion, it is preferred to maintain the temperature in a range of from 50 to 90° C. for 0.5 to 5 hours.

It is preferred to set a solid component concentration in the aqueous dispersion liquid to be subjected to the above-described aggregation and fusion to generally about 3 to 50%, particularly about 5 to 30%.

Subsequently, the aggregated and fused particles are washed with water and dried, whereby toner particles preferably having a volume-based median particle diameter (D50) of from about 5 to 12 μm are obtained.

### [External Additive]

In order to adjust the fluidity or chargeability of the toner particles obtained as described above, inorganic fine particles may be mixed with the toner particles to effect external addition in an amount of from 0.01 to 20% based on the amount of the toner particles. As such inorganic fine particles, silica, titania, alumina, strontium titanate, tin oxide, etc. can be used alone or in admixture of two or more species thereof. It is preferred that as the inorganic fine particles, those surface-treated with a hydrophobizing agent are used from the viewpoint of improvement of environmental stability. Further, other than such inorganic oxides, resin fine particles having a size of 1 μm or smaller can be externally added for improving the cleaning property.

### EXAMPLES

Hereinafter, embodiments will be described more specifically with reference to the following Examples, whereas the scope of the embodiment is not limited to the Examples.

Physical properties described herein including the following description are based on values measured according to the following methods. Physical properties related to a toner were determined by the following methods.

### [Method for Measuring Particle Diameter of Finely Pulverized Particles]

The volume-based median particle diameter of finely pulverized particles was determined based on a particle size distribution measured by using a particle size distribution analyzer according to a laser method (“SALD-7000”, made by Shimadzu Corporation; measurement particle diameter range: 10 nm to 300 μm).

### [Method for Measuring Particle Diameter of Toner Particles]

The volume-based median particle diameter of toner particles was determined based on a particle size distribution measured by using a Coulter counter (“Multisizer 3”, made by Beckman Coulter Inc., aperture diameter: 100 μm, measurement particle diameter range: 2 to 60 μm).

### [Preparation of Resin-Release Agent Mixture Dispersion Liquid 1]

95 Wt. parts of a polyester resin as a binder resin and 5 wt. parts of an ester wax as a release agent were mixed, and the resulting mixture was melt-kneaded by using a twin-screw kneader, set to a temperature of 120° C., to obtain a kneaded material.

The thus-obtained kneaded material was coarsely crushed to a volume-based median particle diameter of 1.2 mm by using a hammer mill made by Nara Machinery Co., Ltd., whereby coarse particles were obtained.

The thus-obtained coarse particles were moderately crushed to a volume-based median particle diameter of 0.05 mm by using Bantam Mill made by Hosokawa Micron Corporation, whereby moderately crushed particles were obtained.

30 Wt. parts of the thus-obtained moderately crushed particles, 1.2 wt. parts of a sodium alkyl benzene sulfonate as an anionic surfactant, 1 wt. part of triethylamine as an amine compound and 67.8 wt. parts of deionized water were processed at 160 MPa and 180° C. by using a high-pressure impact-type pulverizing device by a wet process (“NANO 3000”, made by Beryu Co., Ltd.), whereby a dispersion liquid of resin fine particles having a volume-based median particle diameter of 350 nm was prepared.

### [Preparation of Resin Particle Dispersion Liquid 1]

30 Wt. parts of a polyester resin as a binder resin, 1.5 wt. parts of sodium dodecyl benzene sulfonate as an anionic surfactant, 1 wt. part of triethylamine as an amine compound and 37.5 wt. parts of deionized water were processed at 160 MPa and 150° C. by using NANO 3000, whereby a dispersion liquid of resin fine particles having a volume-based median particle diameter of 150 nm was prepared.

### [Preparation of Colorant Dispersion Liquid 1]

1 Part of 3-(2-ethoxy-4-diethylaminophenyl)-3-(1-ethyl-2-methylindol-3-yl)-4-azaphthalide as a leuco dye, 5 parts of 2,2-bis(4-hydroxyphenyl)hexafluoropropane as a color-developing agent and 50 parts of a diester compound of pimelic acid and 2-(4-benzyloxyphenyl)ethanol as a decoloring agent were dissolved by heating. Then, 20 parts of an aromatic polyvalent isocyanate prepolymer and 40 parts of ethyl acetate were mixed therein as encapsulating agents, and the resulting solution was poured into 250 parts of an aqueous solution of 8% polyvinyl alcohol, and the resulting mixture was emulsified and dispersed. After stirring was continued at 90° C. for about 1 hour, 2 parts of a water-soluble aliphatic modified amine was added thereto as a reaction agent, and stirring was further continued for about 3 hours while maintaining the temperature of the liquid at 90° C., whereby colorless capsule particles were obtained. Further, the resulting dispersion of the capsule particles was placed in a freezer to form a color, whereby a dispersion of blue-colored particles C1 was obtained. The volume-based median particle diameter of the colored particles C1 was measured at 2 μm by using “SALD-7000”, made by Shimadzu Corporation. Further, the colored particles C1 had a completely decoloring temperature Th of 85° C. and a completely coloring temperature Tc of −5° C.

### Example 1

15 Wt. parts of Resin-release agent dispersion liquid 1, 1.7 wt. parts of Colorant dispersion liquid 1 and 68.5 wt. parts of deionized water were added and mixed. Then, 5 wt. parts of an aqueous solution of 5 wt. % aluminum sulfate as an aggregating agent was added thereto at 30° C. After adding the metal salt, the temperature was raised to 40° C., and the resulting mixture was left for 1 hour (D50: 8.02 μm). Thereafter, 7.5 wt. parts of the resin dispersion liquid 1 was additionally added over 2 hours, and aggregation was allowed to proceed (D50: 9.85 μm). Then, after 10 wt. parts of an aqueous solution of 10 wt. % sodium polycarboxylate was added thereto, the temperature was raised to 75° C., and the resulting mixture was left for 1 hour.

After cooling, the solid component in the thus-obtained dispersion liquid was washed by repeating centrifugation using a centrifuge, removal of a supernatant and washing with deionized water until the electrical conductivity of the supernatant was lowered to 50 μS/cm. Then, the washed solid component was dried by using a vacuum dryer until the water content was lowered to 1.0 wt. % or less, whereby toner particles were obtained (D50: 9.82 μm).

After the drying, 2 wt. parts of hydrophobic silica and 0.5 wt. part of titanium oxide were attached as additives to surfaces of the toner particles, whereby a desired electrophotographic toner was obtained.

### Example 2

15 Wt. parts of Resin-release agent dispersion liquid 1, 1.7 wt. parts of the colorant dispersion liquid 1 and 68.5 wt.

parts of deionized water were added and mixed. Then, 3 wt. parts of an aqueous solution of 5 wt. % aluminum sulfate as an aggregating agent was added thereto at 30° C. After adding the metal salt, the temperature was raised to 40° C., and the resulting mixture was left for 1 hour (D50: 5.19 μm). Thereafter, 7.5 wt. parts of the resin dispersion liquid 1 was additionally added over 5 hours, and aggregation was allowed to proceed (D50: 10.37 μm). Then, after 7 wt. parts of an aqueous solution of 10 wt. % sodium polycarboxylate was added thereto, the temperature was raised to 75° C., and the resulting mixture was left for 1 hour.

After cooling, the solid component in the thus-obtained dispersion liquid was washed by repeating centrifugation using a centrifuge, removal of a supernatant and washing with deionized water until the electrical conductivity of the supernatant was lowered to 50 μS/cm. Then, the washed solid component was dried by using a vacuum dryer until the water content was lowered to 1.0 wt. % or less, whereby toner particles were obtained (volume-based median particle diameter: 10.26 μm).

After the drying, 2 wt. parts of hydrophobic silica and 0.5 wt. part of titanium oxide were attached as additives to surfaces of the toner particles, whereby a desired electrophotographic toner was obtained.

### Example 3

15 Wt. parts of Resin-release agent dispersion liquid 1, 1.7 wt. parts of Colorant dispersion liquid 1 and 68.5 wt. parts of deionized water were added and mixed. Then, 4 wt. parts of an aqueous solution of 5 wt. % aluminum sulfate as an aggregating agent was added thereto at 30° C. After adding the metal salt, the temperature was raised to 40° C., and the resulting mixture was left for 1 hour (D50: 6.81 μm). Thereafter, 7.5 wt. parts of the resin dispersion liquid 1 was additionally added over 4 hours, and aggregation was allowed to proceed (D50: 10.14 μm). Then, after 10 wt. parts of an aqueous solution of 10 wt. % sodium polycarboxylate was added thereto, the temperature was raised to 75° C., and the resulting mixture was left for 1 hour.

After cooling, the solid component in the thus-obtained dispersion liquid was washed by repeating centrifugation using a centrifuge, removal of a supernatant and washing with deionized water until the electrical conductivity of the supernatant was lowered to 50 μS/cm. Then, the washed solid component was dried by using a vacuum dryer until the water content was lowered to 1.0 wt. % or less, whereby toner particles were obtained (D50: 9.92 μm).

After the drying, 2 wt. parts of hydrophobic silica and 0.5 wt. part of titanium oxide were attached as additives to surfaces of the toner particles, whereby a desired electrophotographic toner was obtained.

### Example 4

15 Wt. parts of Resin-release agent dispersion liquid 1, 1.7 wt. parts of Colorant dispersion liquid 1 and 68.5 wt. parts of deionized water were added and mixed. Then, 2 wt. parts of an aqueous solution of 5 wt. % aluminum sulfate as an aggregating agent was added thereto at 30° C. After adding the metal salt, the temperature was raised to 40° C., and the resulting mixture was left for 1 hour (D50: 3.21 μm). Thereafter, 7.5 wt. parts of the resin dispersion liquid 1 was additionally added over 2 hours, and aggregation was allowed to proceed (D50: 9.64 μm). Then, after 8 wt. parts of an aqueous solution of 10 wt. % sodium polycarboxylate was added thereto, the temperature was raised to 75° C., and the resulting mixture was left for 1 hour.

After cooling, the solid component in the thus-obtained dispersion liquid was washed by repeating centrifugation using a centrifuge, removal of a supernatant and washing with deionized water until the electrical conductivity of the supernatant was lowered to 50 μS/cm. Then, the washed solid component was dried by using a vacuum dryer until the water content was lowered to 1.0 wt. % or less, whereby toner particles were obtained (D50: 9.61 μm).

After the drying, 2 wt. parts of hydrophobic silica and 0.5 wt. part of titanium oxide were attached as additives to surfaces of the toner particles, whereby a desired electrophotographic toner was obtained.

### Comparative Example 1

15 Wt. parts of Resin-release agent dispersion liquid 1, 1.7 wt. parts of Colorant dispersion liquid 1 and 68.5 wt. parts of deionized water were added and mixed. Then, 5 wt. parts of an aqueous solution of 5 wt. % aluminum sulfate as an aggregating agent was added thereto at 30° C. After adding the metal salt, the temperature was raised to 40° C., and the resulting mixture was left for 1.5 hours (D50: 8.54 μm). Thereafter, 7.5 wt. parts of the resin dispersion liquid 1 was added over 5 minutes (D50: 8.57 μm). Then, after 10 wt. parts of an aqueous solution of 10 wt. % sodium polycarboxylate was added thereto, the temperature was raised to 75° C., and the resulting mixture was left for 1 hour.

After cooling, the solid component in the thus-obtained dispersion liquid was washed by repeating centrifugation using a centrifuge, removal of a supernatant and washing with deionized water until the electrical conductivity of the supernatant was lowered to 50 μS/cm. Then, the washed solid component was dried by using a vacuum dryer until the water content was lowered to 1.0 wt. % or less, whereby toner particles were obtained (D50: 8.62 μm).

After the drying, 2 wt. parts of hydrophobic silica and 0.5 wt. part of titanium oxide were attached as additives to surfaces of the toner particles, whereby a desired electrophotographic toner was obtained.

### Comparative Example 2

15 Wt. parts of Resin-release agent dispersion liquid 1, 1.7 wt. parts of Colorant dispersion liquid 1 and 68.5 wt. parts of deionized water were added and mixed. Then, 5 wt. parts of an aqueous solution of 5 wt. % aluminum sulfate as an aggregating agent was added thereto at 30° C. After adding the metal salt, the temperature was raised to 40° C., and the resulting mixture was left for 1.5 hours (D50: 8.74 μm). Then, after 10 wt. parts of an aqueous solution of 10 wt. % sodium polycarboxylate was added thereto, the temperature was raised to 75° C., and the resulting mixture was left for 1 hour.

After cooling, the solid component in the thus-obtained dispersion liquid was washed by repeating centrifugation using a centrifuge, removal of a supernatant and washing with deionized water until the electrical conductivity of the supernatant was lowered to 50 μS/cm. Then, the washed solid component was dried by using a vacuum dryer until the water content was lowered to 1.0 wt. % or less, whereby toner particles were obtained (D50: 8.72 μm).

After the drying, 2 wt. parts of hydrophobic silica and 0.5 wt. part of titanium oxide were attached as additives to surfaces of the toner particles, whereby a desired electrophotographic toner was obtained.

### Comparative Example 3

15 Wt. parts of Resin-release agent dispersion liquid 1, 1.7 wt. parts of Colorant dispersion liquid 1 and 68.5 wt. parts of deionized water were added and mixed. Then, 2 wt. parts of an aqueous solution of 5 wt. % aluminum sulfate as an aggregating agent was added thereto at 30° C. After adding the metal salt, the temperature was raised to 40° C., and the resulting mixture was left for 0.5 hour (D50: 2.15 μm). Thereafter, 7.5 wt. parts of the resin dispersion liquid 1 was additionally added over 2 hours, and aggregation was allowed to proceed (D50: 9.74 μm). Then, after 8 wt. parts of an aqueous solution of 10 wt. % sodium polycarboxylate was added thereto, the temperature was raised to 75° C., and the resulting mixture was left for 1 hour.

After cooling, the solid component in the thus-obtained dispersion liquid was washed by repeating centrifugation using a centrifuge, removal of a supernatant and washing with deionized water until the electrical conductivity of the supernatant was lowered to 50 μS/cm. Then, the washed solid component was dried by using a vacuum dryer until the water content was lowered to 1.0 wt. % or less, whereby toner particles were obtained (D50: 9.75 μm).

After the drying, 2 wt. parts of hydrophobic silica and 0.5 wt. part of titanium oxide were attached as additives to surfaces of the toner particles, whereby a desired electrophotographic toner was obtained.

The toners obtained in the above Examples and Comparative Examples were evaluated with respect to the following evaluation items according to the following standards.

### <Incorporation of Colorant>

A particle size distribution was measured by using Multisizer 3 (made by Beckman Coulter Inc., aperture diameter: 50 μm, measurement particle diameter range: 1.0 to 30 μm), and the incorporation of the colorant was evaluated based on the amount of fine powder having a number-average particle diameter of from 1 to 2.5 μm according to the following standards.

A: 25% or less

B: more than 25% and 35% or less

C: more than 35%.

### <Image Density>

A solid image (amount of attached toner: 0.6 mg/cm²) was outputted by using an MFP (e-STUDIO 4520C) made by Toshiba Tec Corporation. The image density (ID) of the solid image output by setting the temperature of a fixing device to 85° C. and adjusting the paper conveying speed to 30 mm/sec, was measured by using a Macbeth reflection densitometer RD-19I, and based on the obtained measurement value, the evaluation was performed according to the following standards.

A: ID=0.5 or more

B: ID=0.45 or more and less than 0.5

C: ID=less than 0.45.

### <Anti-Off Set Property>

A solid image (amount of attached toner: 0.6 mg/cm²) was outputted by using an MFP (e-STUDIO 4520C) made by Toshiba Tec Corporation. The solid image output by setting the temperature of a fixing device to 160° C. and adjusting the paper conveying speed to 30 mm/sec was placed in a freezer at −30° C. to cause the formation of color again, and the presence or absence of image soiling was confirmed by visual observation and evaluated according to the following criteria.

A: No image soiling.

B: Slight image soiling.

C: Marked image soiling.

### <Filming>

After 10000 sheets of paper (an image with a coverage of 6% was formed on each sheet) were fed through an MFP (e-STUDIO 455) made by Toshiba Tec Corporation modified for evaluation in an environment of 10° C. and 20 RH %, and the presence or absence of the occurrence of filming on the photoconductor was confirmed by visual observation and evaluated according to the following criteria.

A: The occurrence of filming was not observed on the photoconductor.

B: The occurrence of filming was observed at 1 to 3 sites on the photoconductor.

C: The occurrence of filming was observed at at least 4 sites on the photoconductor.

The outlines of the above Examples and Comparative Examples and the obtained results of the evaluation of the toners are summarized and shown in the following Table 1.

TABLE 1

| | Additional | | | | | | | | |
|---|---|---|---|---|---|---|---|---|---|
| | charging of | Volume-based median particle diameter (D50) (μm) | | | | Evaluation | | | |
| | coating resin | Before addition | After addition | After drying | D1/D3 | Incorporation of | Image | | |
| | particles | D1 | D2 | D3 | (%) | colorant | density | Offset | Filming |
| Example 1 | Yes | 8.02 | 9.85 | 9.82 | 82 | A | A | B | B |
| Example 2 | Yes | 5.19 | 10.37 | 10.26 | 51 | A | A | A | A |
| Example 3 | Yes | 6.81 | 10.14 | 9.92 | 69 | A | A | A | A |
| Example 4 | Yes | 3.21 | 9.64 | 9.61 | 33 | A | B | A | A |
| Comparative | Yes | 8.54 | 8.57 | 8.62 | 99 | B | B | C | B |
| Example 1 | | | | | | | | | |
| Comparative | No | 8.74 | — | 8.72 | 100 | C | C | C | C |
| Example 2 | | | | | | | | | |
| Comparative | Yes | 2.15 | 9.74 | 9.75 | 22 | C | C | B | B |
| Example 3 | | | | | | | | | |

From the results shown in the above Table 1, it was found that in the case of the toners of the Examples composed of the toner particles obtained by suppressing the aggregation of only the core material fine particles containing the colorant fine particles and the release agent-containing resin fine particles, and thereafter allowing the aggregation to gradually proceed together with the additionally added coating resin fine particles according to this embodiment, the incorporation of the colorant was favorable (i.e., the release of fine powder was less), a favorable coloring ability (a high image density) was obtained, and offset or filming caused by soiling of the photoconductor occurred less.

While certain embodiments have been described, these embodiments have been presented by way of example only, and are not intended to limit the scope of the inventions. Indeed the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A toner, comprising: encapsulated toner particles each having a core particle composed of an aggregate of core material particles containing at least a colorant and a core material resin and having a coating layer for coating the core particle, which coating layer is composed of a composite aggregate of the core material particles and coating resin particles, wherein the volume-based median particle diameter of the core material is from 30 to 80% of that of the toner particles.

2. The toner according to claim 1, wherein the core material particles are a mixture of colorant particles and core material resin particles.

3. The toner according to claim 2, wherein the core material resin particles further contain a release agent.

4. The toner according to claim 3, wherein the colorant particles comprise an erasable colorant which comprises at least a color-forming compound and a color-developing agent and optionally a decoloring agent, is encapsulated and has a temperature hysteresis.

5. A process for producing a toner, comprising:
aggregating core material particles containing at least a colorant and a core material resin in an aqueous dispersion medium to form core particles;
adding coating resin particles into the aqueous dispersion medium during progress of the formation of the core material when the volume-based median particle diameter of the core particles formed by the aggregation has reached 30 to 83% of that of desired toner particles; and
continuing the aggregation to form a coating layer composed of a composite aggregate of the core material particles and the coating resin particles on the core material, thereby forming encapsulated toner particles.

6. The process according to claim 5, further comprising heating and fusing after forming the coating layer.

7. The process according to claim 6, wherein the core material particles are a mixture of colorant particles and core material resin particles

8. The process according to claim 7, wherein the core material resin particles further contain a release agent.

9. The process according to claim 8, wherein the colorant particles comprise an erasable colorant which includes at least a color-forming compound and a color-developing agent and optionally contains a decoloring agent, is encapsulated and has a temperature hysteresis.
